(19) United States
(12) Patent Application Publication
(10) Pub. No.: US 2025/0151940 A1
(43) Pub. Date: May 15, 2025

(54) BEVERAGE SHAKER AND JUICER

(71) Applicant: Grand Limon LLC, Huntington Beach, CA (US)

(72) Inventor: James Abumrad, Huntington Beach, CA (US)

(73) Assignee: Grand Limon LLC, Huntington Beach, CA (US)

(21) Appl. No.: 18/942,677

(22) Filed: Nov. 9, 2024

Related U.S. Application Data
(60) Provisional application No. 63/598,070, filed on Nov. 11, 2023.

(51) Int. Cl. A47J 19/02; A47J 43/27

(52) U.S. Cl. CPC A47J 19/023; A47J 43/27

(57) ABSTRACT

The invention is a beverage shaker-juicer system the comprises beverage shaker and juicer subsystems into an integrated system.

This application is associated with application No. 63/598,070 and seeks priority with that provisional application's filing date of Nov. 11, 2023.

### TECHNICAL FIELD

The invention is a system that combines a beverage shaker and juicer for preparing beverages comprising mixed ingredients and fruit juicing.

### BACKGROUND OF INVENTION

Many beverages, including mixed cocktails, require mixing and shaking of ingredients and adding juice extracted from citrus fruits.

Often, the beverage requires separate shaker and juicing devices. Some shakers do comprise juicer accessories but their use requires some disassembly and an increased number of preparation steps.

### BRIEF DESCRIPTION OF INVENTION

The invention is a combination beverage shaker and juicer.

The juicer is situated near the top of the shaker and does not require disassembly in order to make use of it.

Rather than requiring a user to exert pressure and twisting a fruit portion in order to extract its juice, the invention's cap structure is designed to securely hold the fruit portion against the juicer subsystem, and rotation of the cap facilitates juice extraction.

After extraction, the cap can be secured allowing the remaining fruit portion to be included in the subsequent shaking process, or to be removed before shaking.

Because of the way the upper portion of the invention is implemented, the juicer does not require that the shape of the shaker be affected in order to accommodate the juicer. In addition, the juicer adds very little to the overall weight of the shaker-juicer combination.

### BRIEF DESCRIPTION OF DRAWINGS

FIG. 1 is an exploded view of the beverage shaker-juicer invention.

FIG. 2 is a cut-away view of the showing more detail of the upper portion.

FIG. 3 is an enlarged view of just the upper portion and its structures.

FIG. 4 shows a perspective view, from above and to the side, of the upper portion and its structures.

FIG. 5 is a top-down view of the upper portion with the cap removed.

FIG. 6 is a perspective view, with the cap on its side, showing the inner structures.

FIG. 7 shows a bottom-up view of the cap and its inner structures.

### DETAILED DESCRIPTION OF INVENTION

The invention is a combination beverage shaker and juicer system. By combining the two functions—shaking and juicing—a single device can be used for preparing beverages that require both ingredient shaking and adding extracted juices from a fruit portion.

Despite the addition of the juicer subsystem to the shaker subsystem, the overall shape of the shaker is consistent with that of a shaker that does not include a juicer. This preserves the aesthetic look of the system while providing extra functionality.

The citrus juicer resides inside the mouth of the shaker in a ready position as opposed to being hidden inside the body of the shaker and requiring the lid to be opened in order to access the juicer.

The bottom of the juicer subsystem lies below the bottom of the opening rim such that the top of the juicer rises minimally above the top of the rim thus preserving the look and profile of a beverage shaker.

The top of the juicer rises slightly above the top of the rim to allow the user access to grabbing and then discarding the citrus fruit portion sitting atop the juicer after juice extraction.

A dual-function cap with an internal gripping structure is operative to support grabbing, pressing and twisting of the citrus fruit portion onto the juicer.

The following descriptions and supporting figures are exemplary of an embodiment of the beverage shaker-juicer invention and should not be seen as limiting the scope the claims.

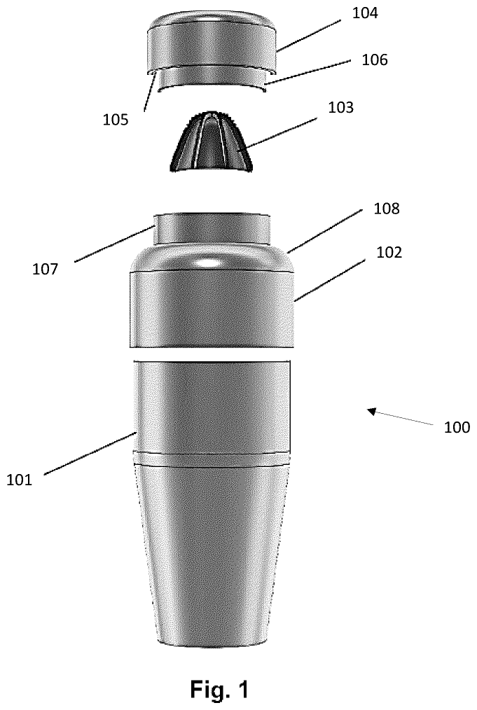

As shown in FIG. 1, an exploded view of the beverage shaker-juicer system (100) shows the subsystems comprising the invention in this embodiment. A bottom portion (101) is operative to contain the contents to be shaken and provide beverage containment prior to pouring. An upper portion (102), called “a lid,” has a wider lower structure that couples to the bottom portion, and a tapered upper structure (107 and 108) that couples to the juicer subsystem (103). The cap subsystem (104) has a wider upper structure that tapers (105, and 106) to couple with the top of the lid subsystem.

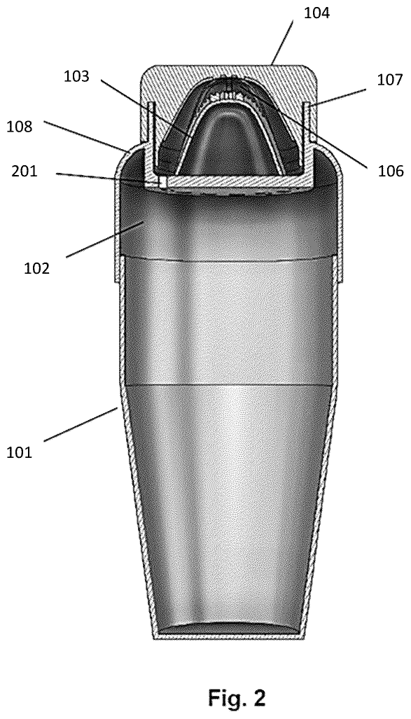

In a cut-away view, FIG. 2, shows the assembled beverage shaker-juicer system, with inner views of the structures depicted in FIG. 1 (101-104, 106-108) plus a view of the strainer structure (201) through which extracted juice and pulp will pass while blocking the passage of any larger materials, such as ice.

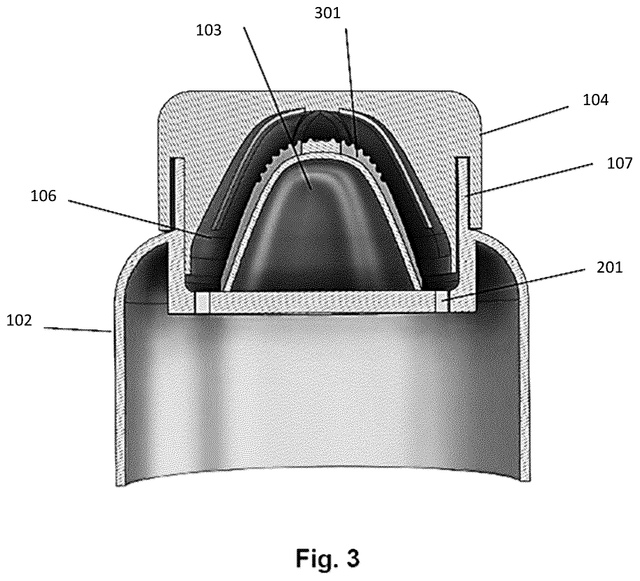

In FIG. 3, the upper portion of the invention is shown in enlarged detail showing the inner view of the structures from FIG. 1 (102-104, 106, and 107) plus the structure from FIG. 2 (201) and 301 showing a plurality of ridge structures on the juicer subsystem (103).

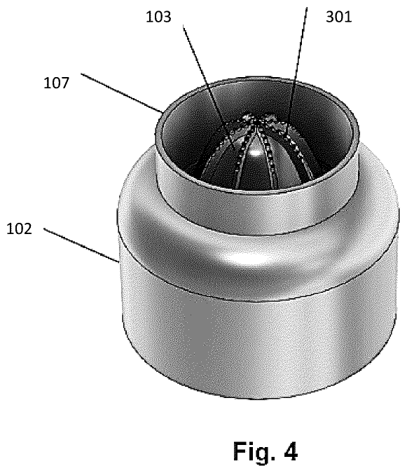

FIG. 4 provides a perspective view from above and to the side of the lid and juicer subsystems (102 and 103) as well as the ridges atop the juicer subsystem (301).

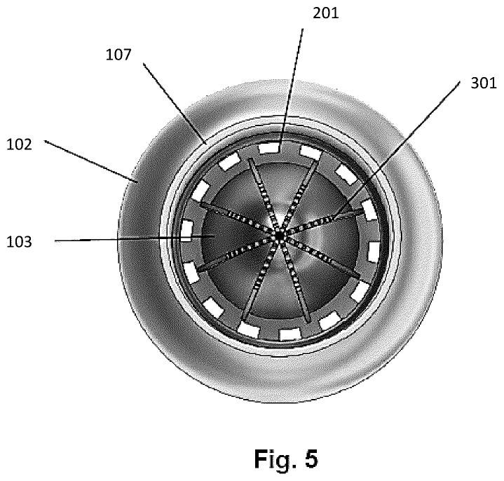

FIG. 5 is an top-down view of the upper portion of the beverage shaker-juicer system showing more detail of the structures of the lid and juicer subsystems (102, 103, 107, 201, and 301).

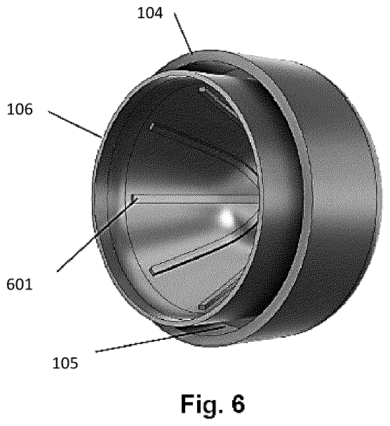

FIG. 6 is a view of the cap (104) resting on its side and viewed so as to show its structures (104, 105, and 106) and inner ridge structures (601) which support grabbing, holding and rotating fruit portions during juice extraction.

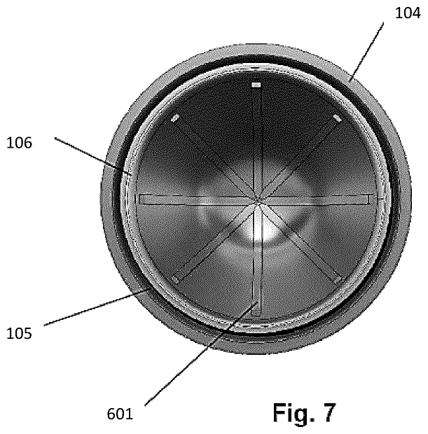

In FIG. 7, the cap (104) is a bottom-up view of the cap (104)'s inner structures (601) as well as other cap structures (105 and 106).

The shaker and its subsystems can be metallic or non-metallic. The criteria for selection are rigidity and materials, or materials coatings, which do not leach into liquids that contain solvents, such as alcohol, or acids, such as citric acid.

Dimensions and volumes are not critical but the upper portion lid should be wide enough to accommodate a juicer subsystem which, in turn, is large enough for extracting juice from an orange-sized fruit portion.

What is claimed is:

1. A beverage shaker-juicer system comprising:
a bottom container subsystem;
a lid subsystem;
a juicer subsystem;
a cap subsystem;
the bottom container is operative to contain liquids to be mixed by shaking;
the lid subsystem is operative to couple atop the bottom container subsystem;
the lid subsystem is operative to couple to the juicer subsystem;
the juicer subsystem is operative to contact juice-containing portions of a fruit portion and support juice extraction when the juice-containing portions are pressed and rotated against a plurality of juicer ridges comprising the juicer subsystem;
the cap subsystem is operative to grab, hold and rotate the fruit portion such that its juice-containing portions are pressed against the plurality of juicer ridges of the juicer subsystem; and
the cap subsystem comprises a plurality of cap ridges operative to support grabbing, holding and rotating the fruit portion during juice extraction.

2. A system as in claim 1 wherein:
the bottom container subsystem is made of metal material.

3. A systems as in claim 1 wherein:
the lid subsystem is made of metal material.

4. A system as in claim 1 wherein:
the juicer subsystem is made of metal material.

5. A system as in claim 1 wherein:
the cap subsystem is made of metal material.

6. A system as in claim 1 wherein:
the bottom container portion is made of non-metal material.

7. A system as in claim 1 wherein:
the lid subsystem is made of non-metal material.

8. A system as in claim 1 wherein:
the juicer subsystem is made of non-metal material.

9. A system as in claim 1 wherein:
the cap subsystem is made of non-metal material.

10. A system as in claim 2 wherein:
the metal material does not leach in the presence of liquids containing alcohol or citric acid.

11. A system as in claim 3 wherein:
the metal material does not leach in the presence of liquids containing alcohol or citric acid.

12. A system as in claim 4 wherein:
the metal material does not leach in the presence of liquids containing alcohol or citric acid.

13. A system as in claim 5 wherein:
the metal material does not leach in the presence of liquids containing alcohol or citric acid.

14. A system as in claim 6 wherein:
the non.metal material does not leach in the presence of liquids containing alcohol or citric acid.

15. A system as in claim 7 wherein:
the non.metal material does not leach in the presence of liquids containing alcohol or citric acid.

16. A system as in claim 8 wherein:
the non.metal material does not leach in the presence of liquids containing alcohol or citric acid.

17. A system as in claim 9 wherein:
the non.metal material does not leach in the presence of liquids containing alcohol or citric acid.
